(19) United States
(12) Patent Application Publication
(10) Pub. No.: US 2008/0212538 A1
(43) Pub. Date: Sep. 4, 2008

(54) Antenna Selection For Multi-Input Multi-Output System

(76) Inventor: Andreas F. Molisch, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/995,390

(22) PCT Filed: Jul. 15, 2005
(86) PCT No.: PCT/US05/25309

§ 371 Date: Jan. 11, 2008

(51) Int. Cl. H04B 7/208

(52) U.S. Cl. 370/334

(57) ABSTRACT

A transmitting station in a radio network includes at least one radio frequency (RF) chain, a packet generator configured to generate a sounding packet including a number of training frames and a signaling frame, and at least one antenna element coupled to the at least one RF chain and configured to broadcast a transmit signal including the sounding packet. The packet generator produces in the sounding packet the number of training frames and the content of the signaling frame based at least in part on the number of antenna elements and the number RF chains.

### CROSS-REFERENCES TO RELATED APPLICATIONS

This application is related to “Multiple Antennas at Transmitters and Receivers to Achieving Higher Diversity and Data Rates in MIMO Systems,” U.S. patent application Ser. No. 10/828,625 filed on Apr. 21, 2004, “Space Time Transmit Diversity With Subgroup Rate Control and Subgroup Antenna Selection in Multi-Input Multi-Output Communications systems,” U.S. patent application Ser. No. 10/828,626 filed on Apr. 21, 2004, “RF Signal Processing in Multi-Antenna Systems,” U.S. patent application Ser. No. 10/629,240 filed on Jul. 29, 2003, “Training Frames for MIMO Stations,” U.S. patent application Ser. No. 11/127,006 filed on May 11, 2005, and “RF-Based Antenna Selection in MIMO Systems,” U.S. patent application Ser. No. 10/877,686 filed on Jun. 25, 2004, the entirety of the disclosures of the aforementioned related applications are incorporated herein by reference.

### BACKGROUND OF THE INVENTION

1. Field of the Invention

The present invention relates generally to wireless communication systems, and more particularly to selecting antennas in multiple-input multiple-output (MIMO) wireless communications systems and in particular, selecting antennas according to the IEEE 802.11n standard.

2. Discussion of the Background

MIMO systems are envisaged for deployment in wireless communications systems designed according to future 3G and 4G standards. The MIMO systems support high data rates and increase capacity and coverage for cellular telephone systems that provide both high rate and low rate services to multiple users in a fixed bandwidth wireless channel.

MIMO systems can also increase the bandwidth and reliability of local area networks, such as networks designed according to the IEEE 802.11n standard. In such networks, the real data throughput will be at least 100-200 Mbit/s, and should be up to 45 times faster than 802.11a or 802.11g, and perhaps 20 times faster than 802.11b. It is projected that 802.11n will also offer a better operating distance than current networks. The 802.11n standard is particularly suited for increasingly popular wireless local area networks (WLAN) and wireless personal networks (WPAN), such as WiFi networks that are being deployed in homes, small businesses, and public facilities such as airports.

Multiple antenna systems exploit spatial characteristics of the channel using spatial multiplexing and transmitting diversity.

The use of MIMO techniques in a wireless communication system may significantly increase capacity in a multipath environment. However, multiple antennas may also increase complexity and cost because each transmitting antenna and each receiving antenna may require a separate radio-frequency (RF) chain which may include a modulator and/or demodulator, an AD/DA converter, an up/down converter, and a power amplifier.

Antenna selection can reduce the number of RF chains, while still taking advantage of the capacity and diversity increase provided by multiple antennas. With antenna selection, each input/output RF chain may be associated with an antenna selected as being best for down-conversion and processing. Antenna selection depends on small-scale fading, which varies with frequency. Alternatively, hybrid antenna selection may involve the selection of multiple best antennas among all the available antennas for processing, in which case as many RF chains are need as there are data streams.

It is useful for a transmitting/receiving station to be able to determine the number of selectable antennas and RF chains in another station. Conventional MIMO systems employ bits in a signaling field that is sent from a transmitting station to a receiving station to communicate the number of selectable antennas and RF chains at the transmitting station. For example, a conventional MIMO system may use 3 bits in a signaling frame to communicate that a transmitting station has up to 8 selectable antennas, and two additional bits to signal that the transmitting station has up to 4 RF chains. However, bits within the signaling field are a scarce resource and may preferably be used for other purposes. Thus, there is a problem with conventional MIMO systems which place too heavy of a burden on bandwidth and signaling field bit resources.

### SUMMARY OF THE INVENTION

According to an embodiment of the present invention, there is provided a transmitting station in a radio network. The transmitting station includes: at least one radio frequency (RF) chain; a packet generator configured to generate a sounding packet including a number of training frames and a signaling frame; and at least one antenna element coupled to the at least one RF chain and configured to broadcast a transmit signal including the sounding packet. The packet generator is configured to produce in the sounding packet the number of training frames and the content of the signaling frame in the sounding packet based at least in part on the number of antenna elements and the number RF chains.

According to another embodiment of the present invention, there is provided a sounding packet for transmission in a radio network from a transmitting station having plural transmitting antenna elements and plural radio frequency (RF) chains to a receiving station. The sounding packet includes: plural training frames, wherein the number of training frames is indicative of the number of transmitting antenna elements and the number of RF chains; and a signaling frame.

According to another embodiment of the present invention, there is provided a method for communicating in a radio network. The method includes steps of: receiving, at a receiving station, a sounding packet via a channel of the radio network from a transmitting station, the sounding packet including a number of training frames and a signaling frame; and determining, at the receiving station, a number of antenna elements and a number of radio frequency (RF) chains in the transmitting station based on the number of training frames and the signaling frame in the sounding packet.

According to another embodiment of the present invention, there is provided a receiving station in a radio network. The receiving station includes: a packet receiving section configured to receive a sounding packet via a channel in the radio network, the sounding packet including a number of training frames and a signaling frame; and a determining section configured to determine a number of antenna elements and a number of radio frequency (RF) chains of a transmitting station based on the number of training frames and the signaling frame in the sounding packet.

According to another embodiment of the present invention, there is provided a radio communication system including: a transmitting station having at least one antenna element and at least one radio frequency (RF) chain; and a receiving station configured to receive a sounding packet on a channel from the transmitting station, the sounding packet including a number of training frames and a signaling frame indicative of a number of the antenna elements and a number of the RF chains in the transmitting station. The receiving station is further configured to determine the number of the antenna elements and the number of the RF chains and to select at least one communication parameter for communicating in the radio communication system based at least in part on the determined number of antenna elements and RF chains in the transmitting station.

According to another embodiment of the present invention, there is provided a computer program product storing a program which when executed by a processor in a receiver of in a radio network causes the processor to perform steps of: receiving, at a receiving station, a sounding packet on a channel in the radio network from a transmitting station, the sounding packet including a number of training frames and a signaling frame; and determining, at the receiving station, a number of antenna elements and a number of radio frequency (RF) chains in the transmitting station based on the number of training frames and the signaling frame in the sounding packet.

According to another embodiment of the present invention, there is provided a method for selecting an antenna in a MIMO radio system. The method includes steps of: receiving a sounding packet via a channel of the radio system from a transmitting station, the sounding packet including a number of training frames and a signaling frame; determining a number of antenna elements and a number of radio frequency (RF) chains in the transmitting station based on the number of training frames and the signaling frame in the sounding packet; and selecting the antenna based on the determined number of antenna elements and the determined number of RF chains in the transmitting station.

### BRIEF DESCRIPTION OF THE DRAWINGS

The features, advantages thereof, and technical and industrial significance of embodiments of the present invention will be better understood by reading the following detailed description of preferred embodiments when considered in connection with the accompanying drawings, in which:

FIG. 1 is a block diagram of a radio network according to an embodiment of the present invention;

FIG. 2 is a block diagram of an exemplary receiving station according to an embodiment of the present invention;

FIG. 3 is a block diagram of an exemplary transmitting station according to an embodiment of the present invention;

FIG. 4A is a signal diagram of an exemplary sounding packet for two transmitting antennas;

FIG. 4B is a signal diagram of an exemplary sounding packet for two-out-of-four receiving antennas;

FIG. 5 is a signal diagram of an exemplary sounding packet for two-out-of-four transmitting antennas; and

FIG. 6 is a flow diagram of method for performing antenna selection according to an embodiment of the present invention.

### DESCRIPTION OF THE PREFERRED EMBODIMENTS

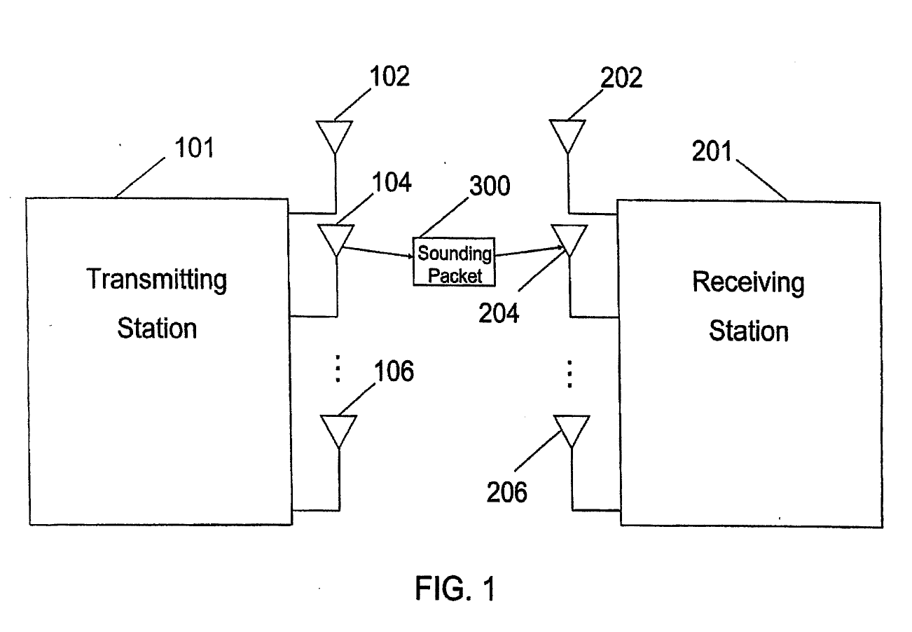

FIG. 1 illustrates an exemplary transmission of a sounding packet 300 from an antenna 104 selected from multiple antennas 102, 104, and 106 at a transmitting station 101 to an antenna 204 selected from multiple antennas 202, 204, and 206 at a receiving station 201. The exemplary transmission of FIG. 1 is not limiting in any way and the number of selected antenna at one or both of the transmitting and receiving stations could be more than one, for example.

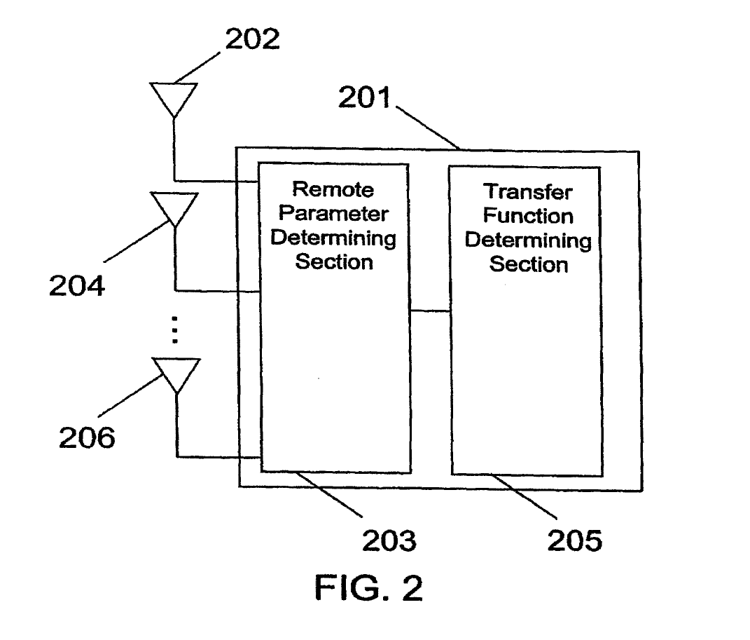

FIG. 2 illustrates exemplary components of the receiving station 201 which include a remote parameter determining section 203 and a transfer function determining section 205. The remote parameter determining section 203 determines parameters regarding the configuration of a remote transmitter, e.g., a transmitting station, from the contents of a signal received by antennas 202/204/206. In particular, the remote parameter determining section 203 is configured to determine a number of selectable antennas at the transmitting station and a number of RF chains at the transmitting station. The remote parameter determining section 203 determines these transmitting station values based on its own configuration, i.e., a number of receiving station antennas and RF chains, a received signal field value, and a received number of long training frames. The number of long training frames may also be encoded within the signaling field to advantageously allow the receiving station to determine the number of long training frames prior to the complete reception of the sounding packet. Further, the receiving station 201 may be configured to determine that a particular portion of a signal received from the transmitting station was transmitted by a particular antenna at the transmitting station. In addition, the receiving station 201 may be configured to associate a determined transfer function of a radio channel determined by the transfer function determining section 205 with the particular transmitting antenna determined to have transmitted the portion of the signal received from the transmitting station.

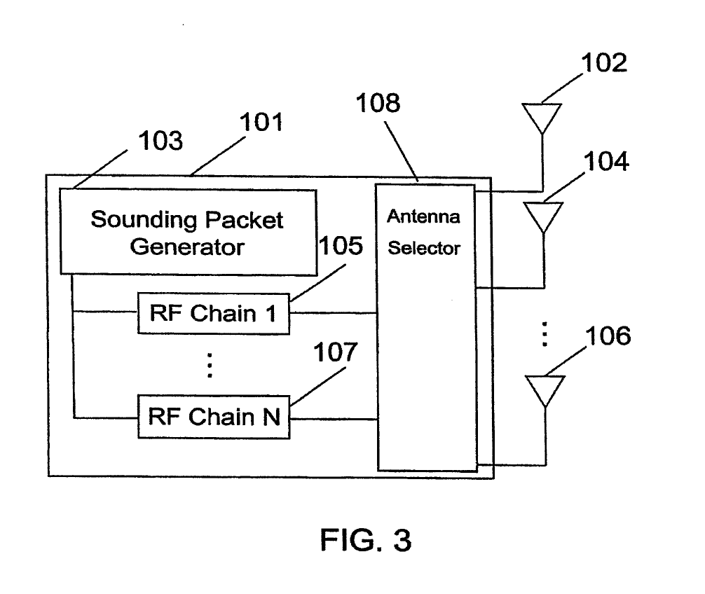

FIG. 3 illustrates exemplary components of the transmitting station 101 which include a sounding packet generator 103 that determines a content of signaling bits and a number of long training frames to send to the receiving station. The transmitting station also includes multiple RF chains 105 and 107. Outputs of the RF chains are connected to an antenna selector 108, which in turn is connected to the transmitting antennas 102-104. Outputs of the RF chains are connected to an antenna selector 108, which in turn is connected to the transmit antennas 102-104.

The receiving and transmitting stations of FIGS. 2 and 3 are not limiting in any way and can include other signal processing components as would be obvious to those of ordinary skill in the art.

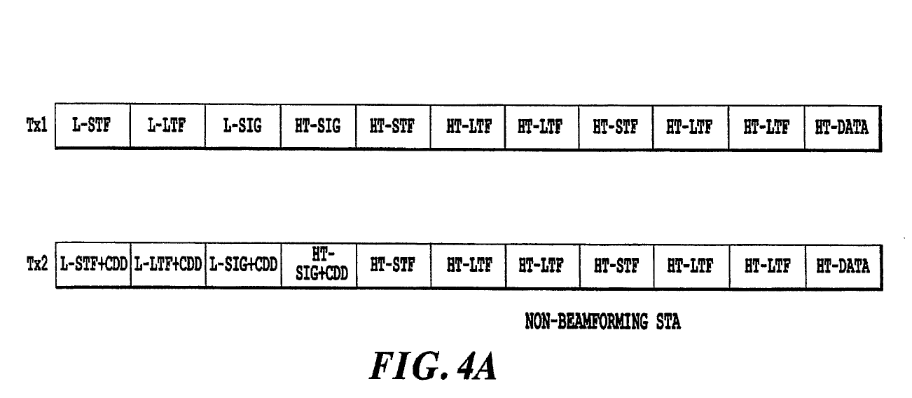

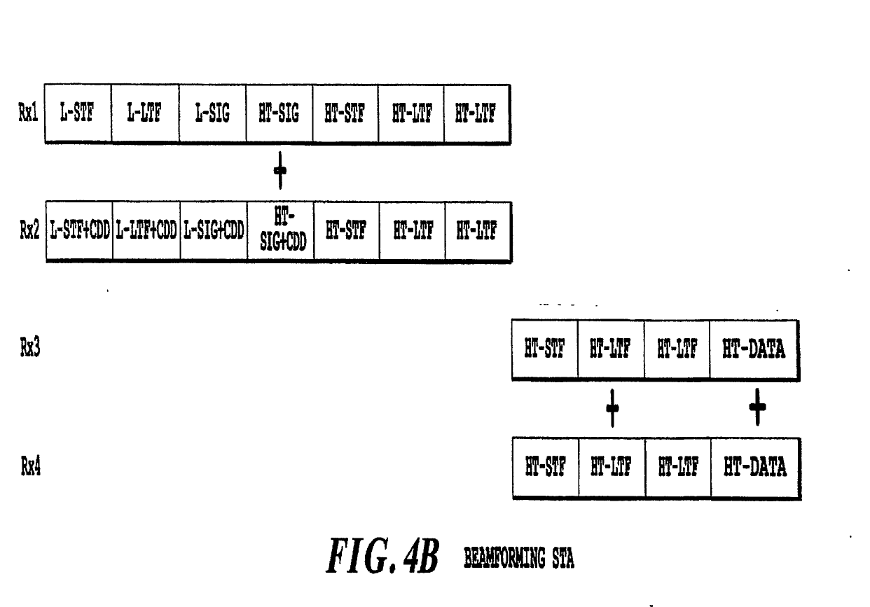

FIG. 4A illustrates exemplary sounding packets transmitted by transmitting antennas Tx1 and Tx2 in a transmitting station having two antennas. The sounding packets include multiple frames including Legacy Short Training Frames (L-STF), Legacy Long Training Frames (L-LTF), Legacy Signaling Frames (L-SIG), High-Throughput Short Training Frames (HT-STF), High-Throughput Long Training Frames (HT-LTF), and data (HT-DATA). The “Legacy” frames refer to frames according to previous versions of the IEEE 802.11 standard. The High-Throughput refer to frames according to draft IEEE 802.11n standard specifications currently being developed and regarding which a draft document titled “PHY subsection Tech Spec 889r7” including a recent version of the specifications is incorporated herein by reference, and within which certain features of the present invention would preferably be incorporated. Specifically, embodiments of the present invention include the reinterpretation and addition of bits in the HT-SIG frame for indicating an antenna selection sounding packet and the use, by the receiver, of the number of HT-LTF frames in the sounding packet to determine the number of antennas and number of RF chains in the transmitting station.

FIG. 4B illustrates the exemplary sounding packets of FIG. 4A received by four receiving antennas at a receiving station having four antennas and two RF chains. The sounding packets include multiple frames including L-STF, L-LTF, L-SIG, HT-STF, HT-LTF, and HT-DATA. In FIG. 4B, for example, the first six transmitted segments are received simultaneously at antennas Rx1 and Rx2. Thereafter, antennas Rx3 and Rx4 receive the next HT-STF and HT-LTF frames as well as the data frames.

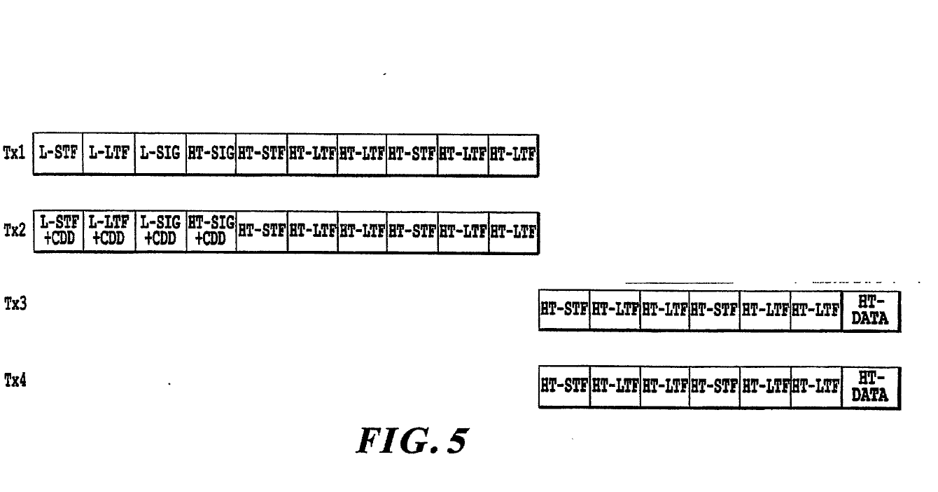

FIG. 5 illustrates another pair of exemplary signals including frames which are transmitted from a transmitting station having four antennas and two RF chains and received at a receiving station having four antennas and two RF chains.

In determining the antenna configuration of the transmitting station at the receiving station, which is aware of its own antenna configuration, the receiving station examines a sounding packet sent by the transmitting station and determines the number of HT-LTF segments in the sounding packet. In particular, the receiving station can determine the number of HT-LTF segments from appropriate bits in the signaling field. According to embodiments of the present invention, the receiving station determines, in light of applied configuration constraints, the antenna configuration at the transmitting station based on (1) the number of HT-LTF segments included in the sounding packet and (2) the contents of the HT-SIG segment which may include an additional bit and/or reinterpreted bits. The number of HT-LTF segments included in the sounding packet may be determined by counting the received number of HT-LTF segments or by examining an HT-SIG bit field including the number of HT-LTF segments. The transmitting station may be configured during communication link setup to know how many HT-LTFs to include in the sounding packet.

Further, the receiving station may be configured to determine which antenna or antennas at the transmitting station transmitted each of the HT-LTFs in the sounding packet, and may then associate a determined transfer function with the determined antenna. Based on the association of the determined transfer function with the determined antenna, the receiving station may inform the transmitting station to transmit using the determined antenna when communicating with the receiving station.

Table 1 includes exemplary cases illustrating the determination of the antenna configuration based on the observed number of HT-LTF segments and the additional bit. In Table 1, the transmitter and receiver configurations are characterized by a value indicating the number of antennas and the number of RF chains or a value indicating the total number of antennas followed by a value in parentheses indicating the number of RF chains when that number differs from the number of antennas. In cases 15 and 16, when the number of LTFs is limited to eight, the transmitter is forced to use only the first four available antenna elements.

TABLE 1
Exemplary Admissible Configurations

| | Transmitter | Receiver | HT-LTF | Extra |
|---|---|---|---|---|
| Case | Configuration | Configuration | segments | Bit |
| 1 | 2 | 4(2) | 4 | 0 |
| 2 | 2 | 8(4) | 4 | 0 |
| 3 | 3 | 4(2) | 6 | 0 |
| 4 | 3 | 8(4) | 6 | 1 |
| 5 | 4 | 4(2) | 8 | 0 |
| 6 | 4 | 8(4) | 8 | 0 |
| 7 | 4(2) | 2 | 4 | 0 |
| 8 | 4(2) | 3 | 4 | 0 |
| 9 | 4(2) | 4 | 4 | 0 |
| 10 | 4(2) | 4(2) | 8 | 1 |
| 11 | 4(2) | 8(4) | 8 | 1 |
| 12 | 8(4) | 2 | 8 | 0 |
| 13 | 8(4) | 3 | 8 | 0 |
| 14 | 8(4) | 4 | 8 | 0 |

| | | | |
|---|---|---|---|
| 15 | 8(4) 4(2) | (16->)8 | Make it into 4(4) |
| | | | at transmitter |
| 16 | 8(4) 8(4) | (16->)8 | Make it into 4(4) |
| | | | at transmitter |

For example, if a receiver observes four HT-LTF segments and the receiver has a “4(2)” configuration, i.e., four antennas and two RF chains, then there is only one possibility for the transmitter configuration: the “2” configuration of case 1. As another example, if a receiver observes eight HT-LTF segments and the receiver has a “4(2)” configuration, then there are two possibilities for the transmitter configuration: the “4” configuration of case 5 and the “4(2)” configuration of case 9. In such a situation, the receiver examines the extra bit to determine the decision, i.e., if the extra bit is “1” in this situation, then the transmitter configuration is “4(2).”

Embodiments of the present invention enable the receiver to determine the antenna configuration of the transmitter with a minor modification of the suggested IEEE 802.11n standard specification.

Subsequently, a channel transfer function can be derived based on the antenna configuration, i.e., the number of selectable antennas and the number of RF chains.

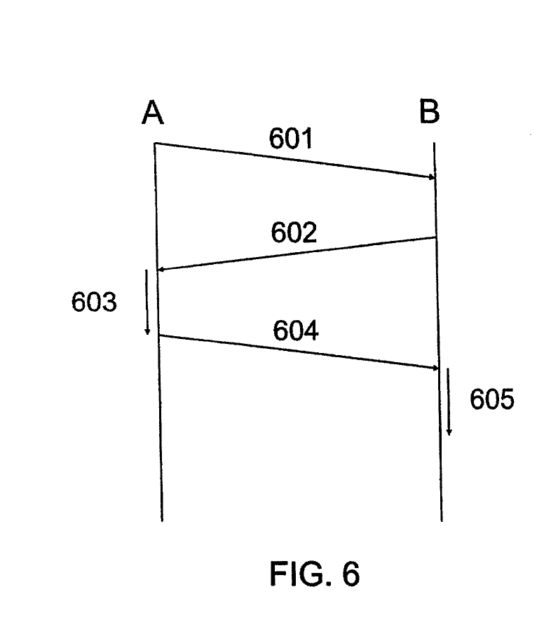

FIG. 6 illustrates an alternative embodiment of the present invention directed to a “dual” MIMO system in which both the transmitting station and the receiving station perform antenna selection. For example, a transmitting station A sends a sounding request packet to receiving station B in step 601. In response, receiving station B sends a sounding packet to transmitting station A in step 602. In step 603, transmitting station A determines the antenna configuration based on the sounding packed received from receiving station B. Then, transmitting station A sends, to receiving station B in step 604, sounding packets so that the transmitting antennas at A are the selected antennas. In step 605, receiving station B performs antenna selection based on the received sounding packets and the channel submatrix associated with the antennas selected at A.

Minor changes to the MAC defined in draft IEEE 802.11n proposed standard may have to be made to support this invention. For instance, a request for sounding with antenna selection may be defined with a new parameter TRQ2 in the initiation aggregation unit (IAU) of the MAC protocol data unit (MPDU), or a new bit in the existing TRQ that signifies request for sounding with antenna selection. Further, parameter BEAMFORMED RF, which has a value of 0 or 1, and parameter BEAMFORMED RF MATRIX, which has a value given by a complex matrix whose dimensions are prescribed by the number of selected antennas and the number of RF chains, may be used. Furthermore, in the particular case in which both stations perform antenna selection, a master/slave bit indicating which station initiates sounding may be introduced.

The present invention includes processing of a received signal, and programs by which the received signal is processed. Such programs are typically stored and executed by a processor in a wireless receiver implemented in VLSI. The processor typically includes a computer program product for holding instructions programmed and for containing data structures, tables, records, or other data. Examples are computer readable media such as compact discs, hard disks, floppy disks, tape, magneto-optical disks, PROMs (EPROM, EEPROM, flash EPROM), DRAM, SRAM, SDRAM, or any other magnetic medium, or any other medium from which a processor can read.

The computer program product of the invention may include one or a combination of computer readable media, to store software employing computer code devices for controlling the processor. The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

While the invention has been described with reference to exemplary embodiments thereof, it is to be understood that the invention is not limited to the exemplary embodiments in any way and that the invention is intended to cover all the various modifications and equivalent steps which one of ordinary skill in the art would appreciate upon reading this specification.

1. A transmitting station in a radio network, the transmitting station comprising:
at least one radio frequency (RF) chain;
at least one antenna element coupled to the at least one RF chain and configured to broadcast a transmit signal including a sounding packet; and
a packet generator configured to generate the sounding packet including a number of training frames and a signaling frame, the training frames and the signaling frame specifying the number of antenna elements and the number of RF chains in the transmitting station.

2. The transmitting station of claim 1, wherein the sounding packet further includes at least one legacy training frame and at least one legacy signaling frame.

3. The transmitting station of claim 1, wherein each of the at least one antenna elements includes a switchable antenna element configured to selectably transmit at least a portion of the sounding packet.

4. The transmitting station of claim 1, wherein each of the RF chains is further configured to concurrently amplify a different signal.

5. The transmitting station of claim 1, wherein the sounding packet includes an IEEE 802.11n standard sounding packet, and at least one of a value of a BEAMFORMED RF parameter and a value of a BEAMFORM RF MATRIX parameter in the IEEE 802.11n standard sounding packet is based on at least one of the number of antenna elements and the number of RF chains.

6. A sounding packet for transmission in a radio network from a transmitting station having at least one transmitting antenna element and at least one radio frequency (RF) chain to communicate to a receiving station information regarding the number of transmitting antenna elements and the number of RF chains, the sounding packet comprising:
plural training frames; and
a signaling frame,
wherein the plural training frames and the signaling frame define the number of transmitting antenna elements and the number of RF chains of the transmitting station.

7. The sounding packet of claim 6, further comprising:
at least one legacy training frame; and
at least one legacy signaling frame.

8. The sounding packet of claim 6, further comprising:
an IEEE 802.11n standard sounding packet, wherein at least one of a value of a BEAMFORMED RF parameter and a value of a BEAMFORM RF MATRIX parameter in the IEEE 802.11n standard sounding packet is based on at least one of the number of antenna elements and the number of RF chains.

9. A method for transmitting information in a radio network, comprising:
determining a number of training frames and a signaling frame to be included in a sounding packet based on a number of antenna elements and a number of radio frequency (RF) chains in a transmitting station;
generating the sounding packet having plural training frames and the signaling frame based on a result of the determining; and
transmitting the generated sounding packet via a channel of the radio network from the transmitting station to a receiving station.

10. The method of claim 9, further comprising:
receiving, at the transmitting station from a receiving station, antenna selection information identifying at least one of plural antenna elements at the transmitting station to be employed for subsequent transmissions from the transmitting station to the receiving station; and
selecting an antenna element at the transmitting station for subsequent transmitting from the transmitting station to the receiving station based on the antenna selection information received at the transmitting station.

11. The method of claim 9, wherein the generating step further comprises:
generating and including in the sounding packet at least one legacy training frame and at least one legacy signaling frame.

12. The method of claim 9, further comprising a step of:
amplifying different signals concurrently in each RF chain in the transmitting station for transmission to the receiving station using different respective antenna elements.

13. The method of claim 9, wherein the generating step further comprises:
generating and including in the sounding packet an IEEE 802.11n standard sounding packet; and
performing the determining step based on at least one of a value of a BEAMFORMED RF parameter and a value of a BEAMFORM RF MATRIX parameter in the IEEE 802.11n standard sounding packet.

14. A computer program product storing a program which when executed by a processor in a transmitting station in a radio network causes the processor to perform steps of:
determining a number of training frames and a signaling frame to be included in a sounding packet based on a number of antenna elements and a number of radio frequency (RF) chains in the transmitting station;
generating the sounding packet having plural training frames and the signaling frame based on a result of the determining; and
transmitting the generated sounding packet via a channel of the radio network from the transmitting station to a receiving station.

15. The computer program product of claim 14, wherein the stored program when executed by the processor further causes the processor to perform steps of:
receiving, at the transmitting station from a receiving station, antenna selection information identifying at least one of plural antenna elements at the transmitting station to be employed for subsequent transmissions from the transmitting station to the receiving station; and
selecting an antenna element at the transmitting station for subsequent transmitting from the transmitting station to the receiving station based on the antenna selection information received at the transmitting station.

16. The computer program product of claim 14, wherein the stored program when executed by the processor further causes the processor to perform step of:
generating and including in the sounding packet at least one legacy training frame and at least one legacy signaling frame.

17. The computer program product of claim 14, wherein the stored program when executed by the processor further causes the processor to perform step of:
amplifying different signals concurrently in each RF chain in the transmitting station for transmission to the receiving station using different respective antenna elements.

18. The computer program product of claim 14, wherein the stored program when executed by the processor further causes the processor to perform step of:
generating and including in the sounding packet an IEEE 802.11n standard sounding packet; and
performing the determining step based on at least one of a value of a BEAMFORMED RF parameter and a value of a BEAMFORM RF MATRIX parameter in the IEEE 802.11n standard sounding packet.

19. A receiving station in a radio network, comprising:
a packet receiving section configured to receive a sounding packet, the sounding packet including a number of training frames and a signaling frame; and
a determining section configured to determine a number of antenna elements and a number of radio frequency (RF) chains of a transmitting station based on the number of training frames and the signaling frame in the sounding packet.

20. The receiving station of claim 19, further comprising:
a training frame location predicting section configured to predict a location of a training frame in a subsequent sounding packet based at least in part on the number of antenna elements and the number of RF chains of the transmitting station determined in the determining section.

21. The receiving station of claim 19, further comprising:
an identifying section configured to identify an antenna element at the transmitting station used to transmit at least a portion of the sounding packet based at least in part on the number of antenna elements and the number of RF chains of the transmitting station determined in the determining section.

22. The receiving station of claim 19, wherein the sounding packet includes an IEEE 802.11n standard sounding packet, and the determining section is further configured to determine the number of antenna elements and the number of radio frequency (RF) chains of a transmitting station based on at least one of a value of the BEAMFORMED RF parameter and a value of the BEAMFORM RF MATRIX parameter in the IEEE 802.11n standard sounding packet.

23. A method for receiving information in a radio network, comprising:
receiving a sounding packet including plural training frames and a signaling frame via a channel in the radio network; and
determining a number of antenna elements and a number of radio frequency (RF) chains of a transmitting station based at least in part on the number of training frames and the signaling frame in the sounding packet.

24. The method of claim 23, further comprising:
predicting a location of a training frame in a subsequent sounding packet based at least in part on the number of antenna elements and the number of RF chains of the transmitting station determined in the determining step.

25. The method of claim 23, further comprising:
identifying an antenna element at the transmitting station used to transmit at least a portion of the sounding packet based at least in part on the number of antenna elements and the number of RF chains of the transmitting station determined in the determining step.

26. The method of claim 23, wherein the determining step further comprises:
determining the number of antenna elements and the number of RF chains in the transmitting station based at least in part on at least one of a value of an IEEE 802.11n standard BEAMFORMED RF parameter and a value of an IEEE 802.11n standard BEAMFORM RF MATRIX parameter in the sounding packet.

27. A computer program product storing a program which when executed by a processor in a receiving station in a radio network causes the processor to perform steps of:
receiving a sounding packet on a channel in the radio network from a transmitting station, the sounding packet including a number of training frames and a signaling frame; and
determining a number of antenna elements and a number of radio frequency (RF) chains in the transmitting station based at least in part on the number of training frames and the signaling frame in the sounding packet.

28. The computer program product of claim 27, wherein the stored program when executed by the processor further causes the processor to perform step of:
predicting a location of a training frame in a subsequent sounding packet based at least in part on the number of antenna elements and the number of RF chains of the transmitting station determined in the determining step.

29. The computer program product of claim 27, wherein the stored program when executed by the processor further causes the processor to perform step of:
identifying an antenna element at the transmitting station used to transmit at least a portion of the sounding packet based at least in part on the number of antenna elements and the number of RF chains of the transmitting station determined in the determining step.

30. The computer program product of claim 27, wherein the stored program when executed by the processor further causes the processor to perform step of:
determining the number of antenna elements and the number of RF chains in the transmitting station based at least in part on at least one of a value of an IEEE 802.11n standard BEAMFORMED RF parameter and a value of an IEEE 802.11n standard BEAMFORM RF MATRIX parameter in the sounding packet.
